(19) United States
(12) Patent Application Publication
(10) Pub. No.: US 2024/0145997 A1
(43) Pub. Date: May 2, 2024

(54) WIRE HARNESS

(71) Applicant: Yazaki Corporation, Tokyo (JP)

(72) Inventor: Hirohito NAKATA, Makinohara-shi (JP)

(73) Assignee: Yazaki Corporation, Tokyo (JP)

(21) Appl. No.: 18/492,257

(22) Filed: Oct. 23, 2023

(30) Foreign Application Priority Data
Oct. 28, 2022 (JP) 2022-173199

(51) Int. Cl. H01R 13/6474; H01R 4/02

(52) U.S. Cl. CPC H01R 13/6474; H01R 4/023

(57) ABSTRACT

A wire harness includes a twisted cable and a connector, wherein the connector includes a plurality of connector terminals to which conductor portions respectively extending from end portions of the plurality of coated electric wires in the untwisted portion to be in an exposure state are fusion welded; and a connector housing formed of an insulating resin and in which a plurality of terminal accommodation rooms are provided, wherein each of the plurality of terminal accommodation rooms is formed in a tubular shape, and the plurality of connector terminals together with the plurality of coated electric wires in the untwisted portion are accommodated in the plurality of terminal accommodation rooms in a one-to-one correspondence by an accommodation length that is at least longer than a conductor length of the conductor portion connected to each connector terminal in a length direction of each coated electric wire.

### TECHNICAL FIELD

The present invention relates to a wire harness in which a connector is provided in an end portion of a twisted cable.

Priority is claimed on Japanese Patent Application No. 2022-173199, filed Oct. 28, 2022, and the entire disclosure of the Japanese Patent Application is incorporated herein with reference.

### BACKGROUND ART

Conventionally, a wire harness in which a connector is provided in an end portion of a twisted cable having noise resistance is used (For example, referring to Patent Document 1). The twisted cable is formed by twisting together a plurality of coated electric wires, and the wire harness including such twisted cable is provided with an untwisted portion of the coated electric wires in an end portion thereof, and the wire harness is configured by providing a connector in the end portion. Also, as providing the connector in the untwisted portion of the end portion, in order to suppresses the deterioration of the transmission performance, connecting the connector terminal with respect to the end portion of each coated electric wire in the untwisted portion or the like is simultaneously performed to align the wire lengths of the coated electric wires.

Here, crimping is well known as a general connection method for the connector terminal, however, for simultaneously crimping the end portions of the plurality of coated electric wires, it is necessary to secure an arrangement space for the swaging pattern between the wires such that there is a case in which the untwisted portion is preserved longer. On the other hand, the noise suppression structure due to the twisting disappears in such untwisted portion. Accordingly, in the case in which the untwisted portion is preserved longer, the operations such as fitting an impedance matching member into the untwisted portion or the like are performed for the purpose of impedance matching to ensure the transmission performance.

### CITATION LIST

### Patent Documents

[Patent Document 1] JP 2020-061341A

### SUMMARY OF THE INVENTION

### Technical Problem

Here, an example of the impedance matching member described above is a zinc die-cast that is post-plated to ensure the communication performance, however, such impedance matching member is expensive and it is possible to increase the manufacturing cost of the wire harness.

Accordingly, the present invention is made by focusing on the above-described technical problem, and an object of the present invention is to provide a wire harness being able to ensure the transmission performance by using the twisted cable while suppressing the increase of the manufacturing cost.

### Solution to Problem

In order to solve the above-mentioned technical problem, a wire harness includes a twisted cable in which a plurality of coated electric wires are twisted together, and a untwisted portion with a predetermined length is formed in an end portion thereof; and a connector provided in the end portion of the twisted cable, wherein the connector includes a plurality of connector terminals to which conductor portions respectively extending from end portions of the plurality of coated electric wires in the untwisted portion to be in an exposure state are fusion welded; and a connector housing formed of an insulating resin and in which a plurality of terminal accommodation rooms are provided, wherein each of the plurality of terminal accommodation rooms is formed in a tubular shape, and the plurality of connector terminals together with the plurality of coated electric wires in the untwisted portion are accommodated in the plurality of terminal accommodation rooms in a one-to-one correspondence by an accommodation length that is at least longer than a conductor length of the conductor portion connected to each connector terminal in a length direction of each coated electric wire.

### Effect of the Invention

According to the above-described wire harness, it is possible to ensure the transmission performance by using the twisted cable while suppressing the increase of the manufacturing cost.

### BRIEF DESCRIPTION OF THE DRAWINGS

FIG. 1 is a perspective view showing a wire harness according to an embodiment.

FIG. 2 is a dissembled perspective view showing the wire harness shown in FIG. 1.

FIG. 3 is a cross-sectional view showing internal structure of the connector shown in FIG. 1 and FIG. 2 in a cross section taken along a length direction.

FIG. 4 is a schematic view showing parameters for presenting a characteristic impedance “Z0” between conductor portions of two coated electric wires running parallel to each other.

### DESCRIPTION OF EMBODIMENTS

Hereinafter, an embodiment of a wire harness will be described.

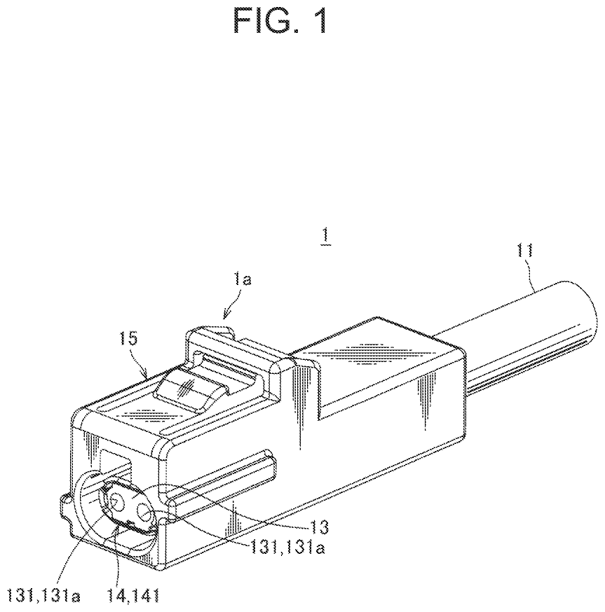

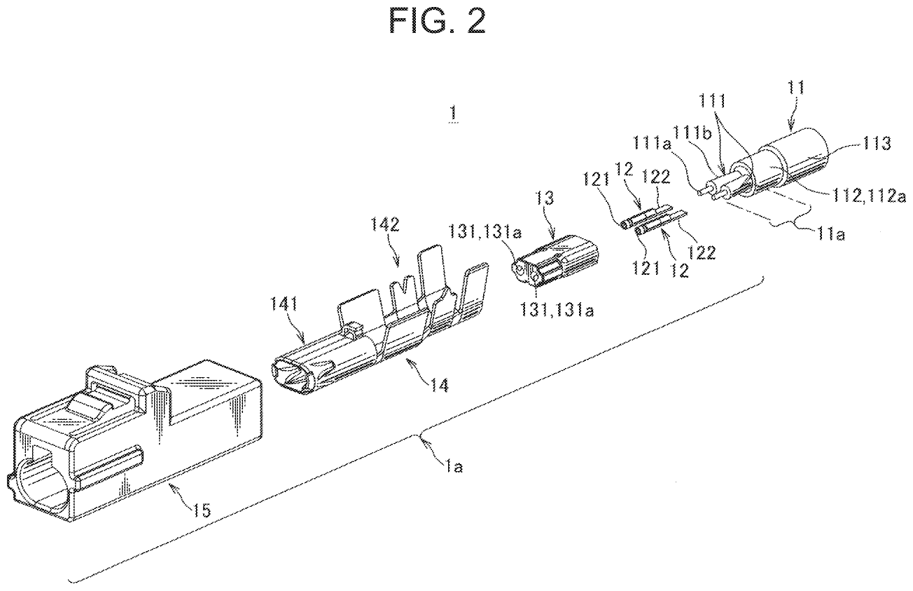

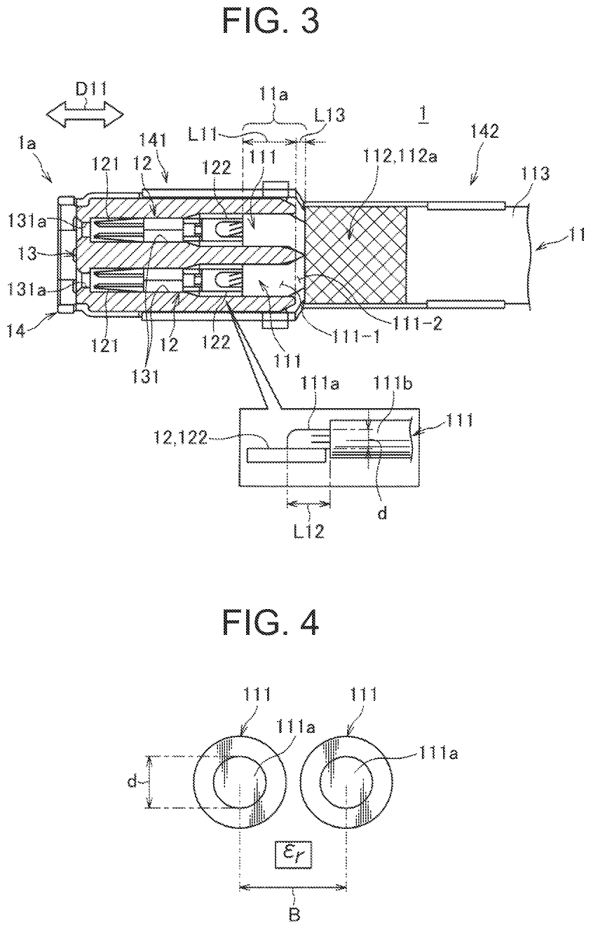

FIG. 1 is a perspective view showing a wire harness according to an embodiment. FIG. 2 is a dissembled perspective view showing the wire harness shown in FIG. 1. FIG. 3 is a cross-sectional view showing internal structure of the connector shown in FIG. 1 and FIG. 2 in a cross section taken along a length direction.

A wire harness 1 according to the present embodiment is a member provided in a vehicle or the like for connecting various devices, for example, and the wire harness 1 includes a twisted cable 11, and a connector 1a in an end portion thereof. The twisted cable 11 is a member that is formed by twisting two coated electric wires 111 together and in which an untwisted portion 11a in a predetermined length 11a is formed in the end portion thereof Also, in the twisted cable 11 according to the present embodiment, two coated electric wires 111 are coated within a conductive braid 112 except for the untwisted portion 11a. In the braid 112, the two coated electric wires 111 are coated by a resin coating 113 except for a braid exposure portion 112a being adjacent to the untwisted portion 11a. A conductor portion 111a in an exposure state from which a coating 111b is removed extends from the end portion of each of the two coated electric wires 111 in the untwisted portion 11a.

The connector 1a provided in the end portion of the twisted cable 11, according to the present embodiment, is a female connector fitting to a mating male connector. This connector 1a includes two connector terminals 12, an inner housing (connector housing) 13, an outer terminal 14, and an outer housing 15.

The connector terminal 12 is a member formed from a conductive metal material, and the connector terminal 12 is the member to which the conductor portion 111a extending from the end portion of each coated electric wire 111 in the untwisted portion 11a is fusion welded. The connector terminal 12 includes a fitting portion 121 in correspondence with the mating terminal, and a connection piece portion 122 extending in a strip-plate shape from the electric wire side in this fitting portion 121. The conductor portion 111a is fusion welded to the connection piece portion 122. Due to the fusion welding, it is possible to achieve a high connection strength in a small connection area, and the laser welding, the resistance welding, the ultrasonic welding and the like can be considered to be specific examples.

The inner housing 13 is a connector housing having an appearance in a substantially elliptic cylindrical shape in which two terminal accommodation rooms 131 formed of an insulating resin are provided in parallel, wherein each of the terminal accommodation rooms 131 is formed in a cylindrical shape. In the connector 1a of the wire harness 1, the terminal accommodation room 131 opens on the end surface at the fitting side with the mating configuration, and the opening is formed as an admission port 131a for the mating male terminal to enter during the fitting. According to the inner housing 13, the two connector terminals 12 together with the two coated electric wires 111 in the untwisted portion 11a are accommodated in the two terminal accommodation rooms 131 in a one-to-one correspondence. At this time, each coated electric wire 111 is accommodated in each terminal accommodation room 131 with an accommodation length L11 that is longer than a conductor length L12 of the conductor portion 111a connected with each connector terminal 12 in the length direction D11.

The outer terminal 14 is formed of the conductive metal material, wherein the outer terminal 14 accommodates the inner housing 13 in a cylindrical accommodation portion thereof while being crimped and connected with the braid exposure portion 112a adjacent to the untwisted portion 11a. The outer terminal 14 includes a housing accommodation portion 141 and a braid crimping portion 142. The housing accommodation portion 141 is a portion formed in an elliptical cylindrical shape in which the inner housing 13 is accommodated, and during the fitting with the mating connector, the housing accommodation portion 141 is connected to a predetermined ground via the specific mating connector. The braid crimping portion 142 is a barrel portion that is crimped and connected to the braid exposure portion 112a. The outer terminal 14 shields a connection portion of the connector terminal 12 and the coated electric wire 111, and when the connector 1a is fitted to the mating connector, the outer terminal 14 functions as a configuration for making the braid 112 to be connected to the predetermined ground via the mating connector.

The outer housing 15 is made of an insulating resin in a rectangular tubular shape and configured to accommodate the outer terminal 14. As shown in FIG. 1, the fitting-side end portion of the housing accommodation portion 141 in the outer terminal 14 and the admission port 131a for the male terminal in the terminal accommodation room 131 of the inner housing 13 are positioned in the opening at the fitting side with the mating configuration of this outer housing 15.

As shown in FIG. 3, according to the present embodiment, all of the untwisted portion 11a, including an accommodation portion 111-1 and a non-accommodation portion 111-2 of the inner housing 13, is accommodated in the housing accommodation portion 141 of the outer terminal 14. At this time, the non-accommodation portion 111-2 in each of the two coated electric wires 111 of the untwisted portion 11a that extends to the outside without being accommodated in the inner housing 13 has a length L13 in the length direction D11 that is further shorter than the conductor length L12 so as to become a minimal length approximately close to “0”. The accommodation length L11 of the accommodation portion 111-1 in the untwisted portion 11a, the conductor length L12 of the conductor portion 111a that is fusion welded to the connector terminal 12, and the length L13 of the non-accommodation portion 111-2 satisfy the dimensional relationship as follows.

That is, the dimensional relationship as “the length L13 of the non-accommodation portion 111-2”<“the conductor length L12”<“the accommodation length L11” is satisfied. Furthermore, according to the present embodiment, the fusion welding of the connector terminal 12 and the conductor portion 111a is performed so as to establish the relationship as “the outer diameter d of the conductor portion 111a”<“the conductor length L12”.

According to the wire harness 1 described above, the insulating resin forming the inner housing 13 is arranged over the above-described accommodation length L11 between the lines of the two coated electric wires 111 in the untwisted portion 11a. At this time, the characteristic impedance “Z0” between the conductor portions 111a of the two coated electric wires 111 running parallel to each other is represented by using the parameters shown in FIG. 4.

FIG. 4 is a schematic view showing the parameters for representing the characteristic impedance “Z0” between the conductor portions of the two coated electric wires running parallel to each other.

The parameter “εᵣ” shown in FIG. 4 is a relative permittivity between the conductor portions 111a of the coated electric wires 111, the parameter “B” is a distance between the conductor portions 111a, and the parameter “d” is an outer diameter of the conductor portion 111a. The characteristic impedance “Z0” is represented by using such parameters in the equation as follows.

$${Z}_{0} = \frac{276}{\sqrt{{ε}_{r}}} log ( \frac{2 B}{d} ) \qquad [ Math 1 ]$$

As can be understood from Math 1, the characteristic impedance “Z0” becomes smaller as the relative permittivity “εᵣ” increases. As described above, with respect to the wire harness 1 according to the present embodiment, the insulating resin forming the inner housing 13 is arranged over the above-described accommodation length L11 between the lines of the two coated electric wires 111 in the untwisted portion 11a. Generally, the relative permittivity εᵣ of the insulating resin is larger than the relative permittivity εᵣ in the air that is near equal to 1 and approximately becomes “three”. Due to the presence of such insulating resin between the lines, the characteristic impedance “Z0” between the conductor portions 111a of the electrical coated electric wires 111 is lower than that in the case where the insulating resin is not present between the lines and is filled with air will drop to approximately 1/(square root of 3). That is, part of the inner housing 13 positioned between the lines of the two coated electric wires 111 in the untwisted portion 11a functions substantially the same as an impedance matching member having the same relative permittivity εᵣ. Accordingly, due to the above-described wire harness 1, it is unnecessary to provide the expensive impedance matching member, thus it is possible to suppress the increase of the manufacturing cost. In other words, due to the wire harness 1 according to the present embodiment, it is possible to ensure the transmission performance by using the twisted cable 11 while suppressing the increase of the manufacturing cost.

According to the present embodiment, the accommodation length L11 of the coated electric wires 111 in the terminal accommodation room 131 is longer than the conductor length L12 of the conductor portion 111a being fusion welded to the connector terminal. Due to the fusion welding, it is possible obtain sufficient connection strength even with a short conductor length L12. Accordingly, even if the accommodation length L11 for securing the transmission performance is longer than the conductor length L12, the conductor length L12 can be shortened such that the length of the terminal accommodation room 131 can be reduced, that is, it is possible to suppress the enlargement of the inner housing 13.

Here, according to the present embodiment, the twisted cable 11 is coated by the braid 112 except for the untwisted portion 11a and coated by the insulating resin coating 113 except for the braid exposure portion 112a. Also, the inner housing 13 is accommodated in the outer terminal 14 connected to the braid exposure portion 112a, and the outer terminal 14 is accommodated in the outer housing 15. According to such configuration, the two coated electric wires 111 are coated by the conductive braid 112 that is grounded to the predetermined ground via the outer terminal 14 during the fitting with the mating connector such that the noise resistance is improved.

According to the present embodiment, the whole of the untwisted portion 11a is accommodated in the housing accommodation portion 141 of the outer terminal 14. According to the configuration, the whole of the untwisted portion 11a, together with the inner housing 13, are accommodated in the insulating outer terminal 14 to be shielded such that it is possible to further improve the noise resistance.

According to the present embodiment, the length L13 of the non-accommodation portion 111-2 in each of the two coated electric wires 111 of the untwisted portion 11a is shorter than the conductor length L12. According to the configuration, the length L13 of the non-accommodation portion 111-2 where the insulating resin is not disposed between the lines in the untwisted portion 11a is suppressed such that it is possible to further prevent the decrease in the transmission performance.

According to the present embodiment, the conductor length L12 is longer than the outer diameter d of the conductor portion 111a. According to the configuration, the conductor portion 111a is fusion welded to the connector terminal 12 by the conductor length L12 that is longer than the outer diameter d of the conductor portion 111a such that it is possible to achieve the high connection strength between the conductor portion 111a and the connector terminal 12.

The embodiment described above merely show a typical aspect of the wire harness. The wire harness is not limited to this configuration and can be configured as various modifications.

For example, according to the above-described embodiment, as an example of the wire harness, the wire harness 1 that is installed in the vehicle or the like for connecting various devices is shown. However, the wire harness is not limited to this configuration, the specific installation target thereof is not limited and can be any configuration in which the connector is provided in the end portion of the twisted cable.

According to the above-described embodiment, as an example of the twisted cable, the twisted cable 11 in which the two coated electric wires 111 are twisted together is shown. However, the number of the coated electric wires that is twisted together in the twisted cable only has to be multiple and the specific number can be appropriately determined in response to the usage purpose.

According to the above-described embodiment, as an example of the connector, the female connector 1a having the connector terminal 12 as the female terminal is shown. However, the connector is not limited to this configuration, and may be the male connector having the male terminal.

According to the above-described embodiment, as an example of the connector, the connector 1a having the inner housing 13 with the elliptic cylindrical shape and the outer housing 15 with the rectangular tubular is shown. However, the connector is not limited to this configuration, and any shape can be adopted as the specific shape of the housing.

According to the above-described embodiment, as an example of the wire harness, the wire harness 1 in which the twisted cable 11 has the braid 112 and the outermost resin coating 113, and the connector 1a has the outer terminal 14 and the outer housing 15 is shown. However, the wire harness is not limited to this configuration, and a configuration in which the braid is not provided in the twisted cable and the outer terminal and the outer housing are not provided in the connector may be adopted. On the contrary, as described above, according to the wire harness 1 having the above-described configuration in which the braid 112 and the like are provided, it is possible to improve the noise resistance.

According to the above-described embodiment, as an example of the wire harness with the above-described configuration in which the braid and the outer terminal are provided, the wire harness 1 in which the whole of the untwisted portion 11a are accommodated in the housing accommodation portion 141 of the outer terminal 14 is shown. However, the wire harness is not limited to this configuration, and part of the untwisted portion may extend to the outside of the housing accommodation portion of the outer terminal. On the contrary, by accommodating the whole of the untwisted portion 11a in the housing accommodation portion 141 of the outer terminal 14, as described above, it is possible to further improve the noise resistance.

According to the above-described embodiment, as an example of the wire harness, the wire harness 1 in which the length L13 of the non-accommodation portion 111-2 of each coated electric wire 111 of the untwisted portion 11a is shorter than the conductor length L12 connected to the connector terminal 12 is shown. However, the wire harness is not limited to this configuration, and the length of the non-accommodation portion of the coated electric wire may be set to be longer than the conductor length. On the contrary, by setting the length of the non-accommodation portion to be shorter than the conductor length, as described above, it is possible to further suppress the decrease of the transmission performance.

According to the above-described embodiment, as an example of the wire harness, the wire harness 1 in which the conductor length L12 is longer than the outer diameter d of the conductor portion 111a is shown. However, the wire harness is not limited to this configuration, and the conductor length may be set to be shorter than the outer diameter of the conductor portion. On the contrary, by setting the conductor length L12 to be longer than the outer diameter d of the conductor portion 111a, as described above, it is possible to obtain the high connection strength between the conductor portion 111a and the connector terminal 12.

### REFERENCE SIGNS LIST

1 wire harness
1a insertion assurance connector
11 twisted cable
11a untwisted portion
12 connector terminal
13 inner housing (connector housing)
14 outer terminal
15 outer housing
111 coated electric wire
111-1 accommodation portion
111-2 non-accommodation portion
111a conductor portion
111b coating
112 braid
112a braid exposure portion
113 resin coating
121 fitting portion
122 connection piece portion
131 terminal accommodation room
131a admission port
141 housing accommodation portion
142 braid crimping portion
B distance between conductor portions
d outer diameter of conductor portion
εᵣ relative permittivity
D11 length direction
L11 accommodation length
L12 conductor length
L13 length of non-accommodation portion

What is claimed is:

1. A wire harness, comprising:
a twisted cable in which a plurality of coated electric wires are twisted together, and an untwisted portion with a predetermined length is formed in an end portion thereof; and
a connector provided in the end portion of the twisted cable,
wherein the connector comprises:
a plurality of connector terminals to which conductor portions respectively extending from end portions of the plurality of coated electric wires in the untwisted portion to be in an exposure state are fusion welded; and
a connector housing formed of an insulating resin and in which a plurality of terminal accommodation rooms are provided, wherein each of the plurality of terminal accommodation rooms is formed in a tubular shape, and the plurality of connector terminals together with the plurality of coated electric wires in the untwisted portion are accommodated in the plurality of terminal accommodation rooms in a one-to-one correspondence by an accommodation length that is at least longer than a conductor length of the conductor portion connected to each connector terminal in a length direction of each coated electric wire.

2. The wire harness according to claim 1,
wherein the twisted cable is configured that the plurality of coated electric wires except for the untwisted portion are coated by a conductive braid, and the plurality of coated electric wires except for a braid exposure portion being adjacent to the untwisted portion in the braid are coated by an insulating resin coating, and
the connector further comprises
an outer terminal formed of a conductive metal material, the outer terminal accommodating the connector housing and being connected to the braid exposure portion; and
an outer housing formed of an insulating resin to accommodate the outer terminal.

3. The wire harness according to claim 2, wherein all of the untwisted portion including the portion being accommodated in the connector housing is accommodated in a housing accommodation portion in which the connector housing is accommodated in the outer terminal.

4. The wire harness according to claim 1, wherein a length of a non-accommodation portion in the length direction is shorter than the conductor length, the non-accommodation portion being a portion of each of the plurality of coated electric wires of the untwisted portion that is not accommodated in the connector housing to extend to the outside.

5. The wire harness according to claim 1, wherein the conductor length is longer than an outer diameter of the conductor portion.
